(19) United States
(12) Patent Application Publication
(10) Pub. No.: US 2018/0206551 A1
(43) Pub. Date: Jul. 26, 2018

(54) BATTERY ASSEMBLY AND ELECTRONIC CIGARETTE

(71) Applicant: KIMREE HI-TECH INC., Road Town,Tortola (VG)

(72) Inventor: Qiuming LIU, SHENZHEN (CN)

(21) Appl. No.: 15/319,928

(22) PCT Filed: Jun. 18, 2014
(86) PCT No.: PCT/CN2014/080196

§ 371 Date: Dec. 19, 2016

(51) Int. Cl. A24F 47/00; H01M 2/10

(52) U.S. Cl. CPC A24F 47/008; H01C 10/32; H01M 2220/30; H01M 2/1055

(57) ABSTRACT

The present application is discloses a battery assembly and an electronic cigarette. The battery assembly comprises: a battery sleeve, a battery sleeved within the battery sleeve, a control module electrically connected to the battery, and an adjustable resistor electrically connected to the control module. One end of the battery sleeve is movably sleeved with an adjustment mechanism used for adjusting the adjustable resistor. The adjustable resistor is adjusted via rotating and pressing the adjustment mechanism, and the output power of the battery assembly is thereby adjusted. When in a normal state, the adjustment mechanism is accommodated within the battery sleeve, preventing false operation. When adjustment of the output power of the battery assembly is required, the adjustment mechanism is extended out of the battery sleeve for adjustment to be performed. Adjustment is convenient and fast, and user experience is improved.

### FIELD OF THE INVENTION

The present application relates to the field of electronic cigarettes substitute, and more particularly relates to a battery assembly and an electronic cigarette.

### BACKGROUND OF THE INVENTION

As illustrated by FIG. 1, an electronic cigarette in the prior art comprises a battery assembly 100 and an atomization assembly 200 which are connected to each other mutually, the battery assembly 100 is provided with a battery 101 configured for supplying electrical power to the atomization assembly 200, a fixed seat 102 is defined at a side of the battery 101 which is opposite to the atomization assembly 200, a control module 103 configured for sensing airflow changes in the electronic cigarette is received in the fixed seat 102. The control module 103 is electrically connected to the battery 101, when the control module 103 senses a smoking signal, the control module 103 controls the electrical connection of the battery 101 and the atomization assembly 200 to be switched on to motivate the atomization assembly to atomize cigarette oil. However, in the electronic cigarette of the prior art, the control module 103 is directly connected to the battery 101, then an output power of the control module 103 is unchanged, and is equal to that of the battery 101, thus, if users want to control a smoke amount of cigarette oil atomization produced by the atomization assembly 200, they can only rely on efforts to adjust a size of smoking intensity, but the smoke amount adjusted by this means is not obvious; and when users require a big smoke volume, they need to strongly smoke the electronic cigarette, it may make users feel difficult, and when users require a small smoke volume, it may have a defect of that the control module 103 cannot sense the airflow changes because of a small smoking intensity, thereby affecting the users experience.

### SUMMARY OF THE INVENTION

Technical problems to be solved in the present invention is to provide a battery assembly and an electronic cigarette which do not require a use of smoking intensity and can adjust a size of smoke volume according to requirements of the users, aiming at defects in the prior art that an adjustment of the smoke volume need to be controlled by the smoke intensity.

The technical solutions of the present application for solving the technical problems are as follows: to provide A battery assembly configured for forming an electronic cigarette in combination with an atomizing assembly, wherein the battery assembly comprises:

A battery sleeve, a battery sleeved within the battery sleeve, a control module electrically connected to the battery, and an adjustable resistor electrically connected to the control module;

One end of the battery sleeve is movably sleeved with an adjustment mechanism configured for adjusting the adjustable resistor, the adjustable resistor is adjusted by rotating the adjustment mechanism, thereby output power of the battery assembly is adjusted;

In a normal state, the adjustment mechanism is accommodated within the battery sleeve; when an adjustment of the output power of the battery assembly is required, the adjustment mechanism is extended out of the battery sleeve for the adjustment to be performed.

In the battery assembly of the present invention, the adjustment mechanism comprises a button which is movable along an axial direction of the battery sleeve, a rotating shaft which is arranged along the axial direction of the battery sleeve and connected to the button in a sliding manner, and an adjustment assembly which is sleeved outside the rotating shaft and is arranged between the button and the adjustable resistor;

When the button is pressed, the button is ejected by the adjustment assembly to make the button is axially limited at a first position of the battery sleeve, the rotating shaft is driven to rotate together with the button by rotating the button to adjust a resistance value of the adjustable resistance;

When the button is pressed again, the button is retracted by the adjustment assembly and is limited in a second position of the battery sleeve.

In the battery assembly of the present invention, the adjustment assembly comprises a positioning cylinder firmly sleeved in the battery sleeve, a sliding cylinder capable of sliding in the positioning cylinder, and an elastic member for providing an elastic force for the sliding cylinder, the button, the sliding cylinder and the elastic member are abutted successively;

A periphery of the button is outwardly extended in a radial direction of the button to form a flange, a protrusion is formed by an inwardly radial extension inside an end surface of the battery sleeve;

When in the first position, the flange is abutted against an end surface of the protrusion; when in the second position, an end of the button which is opposite to the flange is abutted against an inner side wall of the protrusion.

In the battery assembly of the present invention, the sliding cylinder comprises a toothed cylinder which is slidably sleeved inside one end of the positioning sleeve, and a rotating cylinder which is slidably sleeved at the other end of the positioning cylinder, and the toothed cylinder is abutted between the button and the rotating cylinder;

An end surface of the toothed cylinder which is opposite to the button is a toothed end surface, chutes is arranged on an end surface of the positioning sleeve which is close to the rotating cylinder, a part of an end surface of the rotating cylinder which is close to the positioning cylinder is an inclined end surface;

When the button is pressed, the toothed end surface is abutted against the inclined end surface, the button pushes the toothed cylinder together with the rotating cylinder to slide downward and press the elastic member, when sliding to a position that the end surface of the rotating cylinder is slid out of the positioning cylinder, a rotation of the rotating cylinder is happened and the rotating cylinder is sheathed in the positioning cylinder, and an elastic force for upward sliding the toothed cylinder and the rotating cylinder is provided under an action of an elastic restoring force of the elastic member, thereby the button is limited in the first position;

When the button is pressed again, the button pushes the toothed cylinder together with the rotating cylinder to slide downward and press the elastic member, when the rotating cylinder rotates to a position which enables the inclined end surface of the rotating cylinder to be clamped in the chutes, the button is retracted back to the second position.

In the battery assembly of the present invention, at least two projections are arranged with intervals and defined on an outer side wall of the toothed cylinder;

Butt joint grooves for the projections to insert into are defined at an end surface of the positioning cylinder which is close to the button, and notches is defined on a side wall of the positioning cylinder and extended along the butt joint grooves, the chutes and the notches are communicated with each other and are arranged on an end surface of the positioning cylinder which is close to the notches, and quantity of the chutes is the same with quantity of the notches;

An outer side wall of the rotating cylinder is also provided with convex parts defined with intervals, quantity of the convex parts is equal to quantity of the projections, the convex parts and the projections are correspondingly arranged, the inclined end surface is an end surface of the convex parts which is close to the positioning cylinder, and the inclined end surface is convex out of an end surface of the rotating cylinder which is close to the positioning cylinder.

In the battery assembly of the present invention, the button comprises a receiving part which is a inner hollow part and is defined long an axial direction of the button, the receiving part is configured for the rotating shaft to axially slide, and a distance of the rotating shaft sliding in the receiving part is equal to a distance of the elastic member axially moving in the battery sleeve.

In the battery assembly of the present invention, a positioning ring is defined at an end surface of the battery sleeve, the protrusion is a part of the positioning ring sleeved in the battery sleeve.

In the battery assembly of the present invention, the adjuastable resistor comprises a carbon film resistor sheet, a first conductive sheet and a second conductive sheet which are fixed at two ends of the carbon film resistor sheet, and a sliding sheet which is slidably connected to the carbon film resistor sheet, one end of the rotating shaft which is opposite to the button is firmly connected with the sliding sheet, and the sliding sheet can move on the carbon film resistance sheet with a rotation of the rotating shaft.

The present invention further provides a battery assembly configured for forming an electronic cigarette in combination with an atomizing assembly, wherein the battery assembly comprises:

A battery sleeve, a battery sleeved within the battery sleeve, a control module electrically connected to the battery, and an adjustable resistor electrically connected to the control module;

One end of the battery sleeve is movably sleeved with an adjustment mechanism configured for adjusting the adjustable resistor, the adjustable resistor is adjusted by pressing the adjustment mechanism, and output power of the battery assembly is thereby adjusted;

The adjustment mechanism comprises a button which is movable along an axial direction of the battery sleeve, a rotating shaft which is arranged along the axial direction of the battery sleeve and connected to the adjustable resistor in a sliding manner, and an adjustment assembly which is sleeved outside the rotating shaft and is arranged between the button and the adjustable resistor;

The adjustment assembly comprises a positioning cylinder firmly sleeved in the battery sleeve, a toothed cylinder which is slidably sleeved in one end of the positioning cylinder, a rotating cylinder which is slidably sleeved on the other one end of the positioning cylinder, and an elastic member for providing an elastic force for the rotating cylinder and the toothed cylinder, the button, the toothed cylinder, the rotating cylinder and the elastic member are abutted successively;

A periphery of the button is outwardly extended in a radial direction of the button to form a flange, a protrusion is formed by an inwardly radial extension inside an end surface of the battery sleeve;

An end surface of the toothed cylinder which is opposite to the button is a toothed end surface, chutes are arranged on an end surface of the positioning sleeve which is close to the rotating cylinder, an end surface of the rotating cylinder which is close to the positioning cylinder is an inclined end surface;

When the button is pressed, the toothed end surface is abutted against the inclined end surface, the button pushes the toothed cylinder together with the rotating cylinder to slide downward and press the elastic member, when sliding to a position that the end surface of the rotating cylinder is slid out of the positioning cylinder, the rotating cylinder drives the rotating shaft to rotate together and is sheathed in the positioning cylinder, and an elastic force for upward sliding the toothed cylinder and the rotating cylinder is provided under an action of an elastic restoring force of the elastic member, thereby the button is limited in the first position; when in the first position, the flange is abutted against an end surface of the protrusion;

When the button is pressed again, the button pushes the toothed cylinder together with the rotating cylinder to slide downward and press the elastic member, when the rotating cylinder rotates to a position which enables the inclined end surface of the rotating cylinder to be clamped in the chutes, the button is retracted back to the second position, when in the second position, an end of the button which is opposite to the flange is abutted against an inner side wall of the protrusion.

The present invention further provides an electronic cigarette comprising a battery assembly and an atomizing assembly which are connected to each other mutually, wherein the battery assembly comprises:

A battery sleeve, a battery sleeved within the battery sleeve, a control module electrically connected to the battery, and an adjustable resistor electrically connected to the control module;

One end of the battery sleeve is movably sleeved with an adjustment mechanism configured for adjusting the adjustable resistor, the adjustable resistor is adjusted by rotating the adjustment mechanism, and output power of the battery assembly is thereby adjusted;

In a normal state, the adjustment mechanism is accommodated within the battery sleeve; when an adjustment of the output power of the battery assembly is required, the adjustment mechanism is extended out of the battery sleeve for the adjustment to be performed.

In the battery assembly of the present invention, the adjustment mechanism comprises a button which is movable along an axial direction of the battery sleeve, a rotating shaft which is arranged along the axial direction of the battery sleeve and connected to the button in a sliding manner, and an adjustment assembly which is sleeved outside the rotating shaft and is arranged between the button and the adjustable resistor;

When the button is pressed, the button is ejected by the adjustment assembly, and the button is axially limited at a first position of the battery sleeve, the rotating shaft is driven to rotate together with the button by rotating the button to adjust a resistance value of the adjustable resistance;

When the button is pressed again, the button is retracted by the adjustment assembly and is limited in a second position of the battery sleeve.

In the electronic cigarette of the present invention, the adjustment assembly comprises a positioning cylinder firmly sleeved in the battery sleeve, a sliding cylinder capable of sliding in the positioning cylinder, and an elastic member for providing an elastic force for the sliding cylinder, the button, the sliding cylinder and the elastic member are abutted successively;

A periphery of the button is outwardly extended in a radial direction of the button to form a flange, a protrusion is formed by an inwardly radial extension inside an end surface of the battery sleeve;

When in the first position, the flange is abutted against an end surface of the protrusion; when in the second position, an end of the button which is opposite to the flange is abutted against an inner side wall of the protrusion.

In the electronic cigarette of the present invention, the sliding cylinder comprises a toothed cylinder which is slidably sleeved inside one end of the positioning sleeve, and a rotating cylinder which is slidably sleeved at the other end of the positioning cylinder, and the toothed cylinder is abutted between the button and the rotating cylinder;

An end surface of the toothed cylinder which is opposite to the button is a toothed end surface, chutes are arranged on an end surface of the positioning sleeve which is close to the rotating cylinder, a part of an end surface of the rotating cylinder which is close to the positioning cylinder is an inclined end surface;

When the button is pressed, the toothed end surface is abutted against the inclined end surface, the button pushes the toothed cylinder together with the rotating cylinder to slide downward and press the elastic member, when sliding to a position that the end surface of the rotating cylinder is slid out of the positioning cylinder, a rotation of the rotating cylinder is happened and the rotating cylinder is sheathed in the positioning cylinder, and an elastic force for upward sliding the toothed cylinder and the rotating cylinder is provided under an action of the elastic restoring force of the elastic member, thereby the button is limited in the first position;

When the button is pressed again, the button pushes the toothed cylinder together with the rotating cylinder to slide downward and press the elastic member, when the rotating cylinder rotates to a position which enables the inclined end surface of the rotating cylinder to be clamped in the chutes, the button is retracted back to the second position.

In the electronic cigarette of the present invention, at least two projections are arranged with intervals and defined on an outer side wall of the toothed cylinder;

Butt joint grooves for the projections to insert into are defined at an end surface of the positioning cylinder which is close to the button, and notches are defined on a side wall of the positioning cylinder and extended along the butt joint grooves, the chutes and the notches are communicated with each other and are arranged on an end surface of the positioning cylinder which is close to the notches, and quantity of the chutes is the same with quantity of the notches;

An outer side wall of the rotating cylinder is also provided with convex parts defined with intervals, quantity of the convex parts is equal to quantity of the projections, the convex parts and the projections are correspondingly arranged, the inclined end surface is an end surface of the convex parts which is close to the positioning cylinder, and the inclined end surface is convex out of an end surface of the rotating cylinder which is close to the positioning cylinder.

In the electronic cigarette of the present invention, the button comprises a receiving part which is an inner hollow part and is defined long an axial direction of the button, the receiving part is configured for the rotating shaft to axially slide, and a distance of the rotating shaft sliding in the receiving part is equal to a distance of the elastic member axially moving in the battery sleeve.

In the electronic cigarette of the present invention, a positioning ring is defined at an end surface of the battery sleeve, the protrusion is a part of the positioning ring sleeved in the battery sleeve.

In the electronic cigarette of the present invention, the adjuastable resistor comprises a carbon film resistor sheet, a first conductive sheet and a second conductive sheet which are fixed at two ends of the carbon film resistor sheet, and a sliding sheet which is slidably connected to the carbon film resistor sheet, one end of the rotating shaft which is opposite to the button is firmly connected with the sliding sheet, and the sliding sheet can move on the carbon film resistance sheet with a rotation of the rotating shaft.

The present invention further provides an electronic cigarette comprising a battery assembly and an atomizing assembly which are connected to each other mutually, wherein the battery assembly comprises:

A battery sleeve, a battery sleeved within the battery sleeve, a control module electrically connected to the battery, and an adjustable resistor electrically connected to the control module;

One end of the battery sleeve is movably sleeved with an adjustment mechanism configured for adjusting the adjustable resistor, the adjustable resistor is adjusted by pressing the adjustment mechanism, and output power of the battery assembly is thereby adjusted;

The adjustment mechanism comprises a button which is movable along an axial direction of the battery sleeve, a rotating shaft which is arranged along the axial direction of the battery sleeve and connected to the adjustable resistor in a sliding manner, and an adjustment assembly which is sleeved outside the rotating shaft and is arranged between the button and the adjustable resistor;

The adjustment assembly comprises a positioning cylinder firmly sleeved in the battery sleeve, a toothed cylinder which is slidably sleeved in one end of the positioning cylinder, a rotating cylinder which is slidably sleeved on the other one end of the positioning cylinder, and an elastic member for providing an elastic force for the rotating cylinder and the toothed cylinder, the button, the toothed cylinder, the rotating cylinder and the elastic member are abutted successively;

A periphery of the button is outwardly extended in a radial direction of the button to form a flange, a protrusion is formed by an inwardly radial extension inside an end surface of the battery sleeve;

An end surface of the toothed cylinder which is opposite to the button is a toothed end surface, chutes are arranged on an end surface of the positioning sleeve which is close to the rotating cylinder, an end surface of the rotating cylinder which is close to the positioning cylinder is an inclined end surface;

When the button is pressed, the toothed end surface is abutted against the inclined end surface, the button pushes the toothed cylinder together with the rotating cylinder to slide downward and press the elastic member, when sliding to a position that the end surface of the rotating cylinder is slid out of the positioning cylinder, the rotating cylinder drives the rotating shaft to rotate together and is sheathed in the positioning cylinder, and an elastic force for upward sliding the toothed cylinder and the rotating cylinder is provided under an action of an elastic restoring force of the elastic member, thereby the button is limited in the first position; when in the first position, the flange is abutted against an end surface of the protrusion;

When the button is pressed again, the button pushes the toothed cylinder together with the rotating cylinder to slide downward and press the elastic member, when the rotating cylinder rotates to a position which enables the inclined end surface of the rotating cylinder to be clamped in the chutes, the button is retracted back to the second position, when in the second position, an end of the button which is opposite to the flange is abutted against an inner side wall of the protrusion.

Applications of the electronic cigarette and electronic cigarette light emission control method of the present invention has following advantages: by defining an adjustable resistor which is connected to the control module to realize an adjustment of an output power of the battery assembly, and a resistance value of the adjustable resistor can be adjusted by the adjustment mechanism, users only need to press the adjustment mechanism to make the adjustment mechanism automatically rotating to adjust or extend out of the battery sleeve, then rotate the adjustment mechanism to adjust the resistance value of adjustable resistor, thereby the output power of the battery assembly is adjusted, and users experience is improved. Meanwhile, when users do not need to adjust the smoke volume, the adjustment mechanism is accommodated within the battery sleeve, preventing a change of the smoke volume caused by a false operation of the users, and a phenomenon that the adjustment mechanism is careless to be pressed during transportation; and the adjustment method is an easy operation, it is only need to press or/and rotate the adjustment mechanism, thus it is convenient and fast, and user experience is improved.

### BRIEF DESCRIPTION OF THE DRAWINGS

FIG. 1 is an overall structure cutaway view of an electronic cigarette in the prior art;

FIG. 2 is a cutaway view of a battery assembly provided by a first embodiment of the present invention;

FIG. 3 is a cutaway view of a battery assembly in FIG. 2 when in an adjusting state;

FIG. 4 is a circuit diagram of an electronic cigarette comprising a battery assembly provided by the present invention;

FIG. 5 is a part of a structural schematic diagram of the adjustment mechanism in FIG. 2;

FIG. 6 is an explosion diagram of the sliding cylinder and the button;

FIG. 7 is a movement structural schematic diagram of the sliding cylinder when the button in FIG. 2 is pressed;

FIG. 8 is a structural schematic diagram of the sliding cylinder in FIG. 3;

FIG. 9 is a movement structural schematic diagram of the sliding cylinder when the button in FIG. 8 is pressed;

FIG. 10 is a structural schematic diagram of the button in FIG. 9 when it moves inside the battery sleeve;

FIG. 11 is a cutaway view of a battery assembly provided by a second embodiment of the present invention;

FIG. 12 is a structural schematic diagram of the rotating shaft in FIG. 11;

FIG. 13 is a overall structure cutaway view of an electronic cigarette provided by a preferable embodiment of the present invention;

FIG. 14 is a structural schematic diagram of the electronic cigarette in FIG. 13 in a state of adjusting the battery assembly to output power;

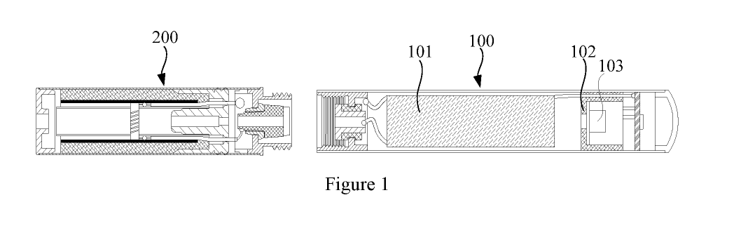

### DETAILED DESCRIPTION OF THE PREFERRED EMBODIMENTS

To make the technical feature, objective and effect of the present application be understood more clearly, now the specific implementation of the present application is described in detail with reference to the accompanying drawings and embodiments.

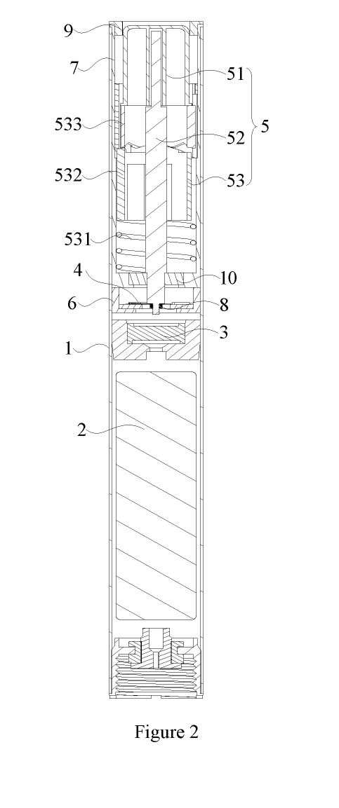

As shown in FIG. 2, the battery assembly provided by the first embodiment of the present invention is configured for forming an electronic cigarette in combination with an atomizing assembly to atomize cigarette oil for users to inhale. The battery assembly comprises a battery sleeve 1, a battery 2, a control module 3, an adjustable resistor 4, an adjustment mechanism 5, a fixing base 6, a fixing sleeve 7, a nut 8, a positioning ring 9 and a bearing 10, the battery sleeve is a hollow cylinder, the battery 2, the control module 3, the adjustable resistor 4, the adjustment mechanism 5, the fixing base 6, the fixing sleeve 7, the nut 8, the positioning ring 9 and the bearing 10 are all sleeved in the battery sleeve 1. The battery 2 is cylindrical in shape, and the battery 2 is an ordinary rechargeable battery, which is configured for supplying electrical power to the atomizing assembly.

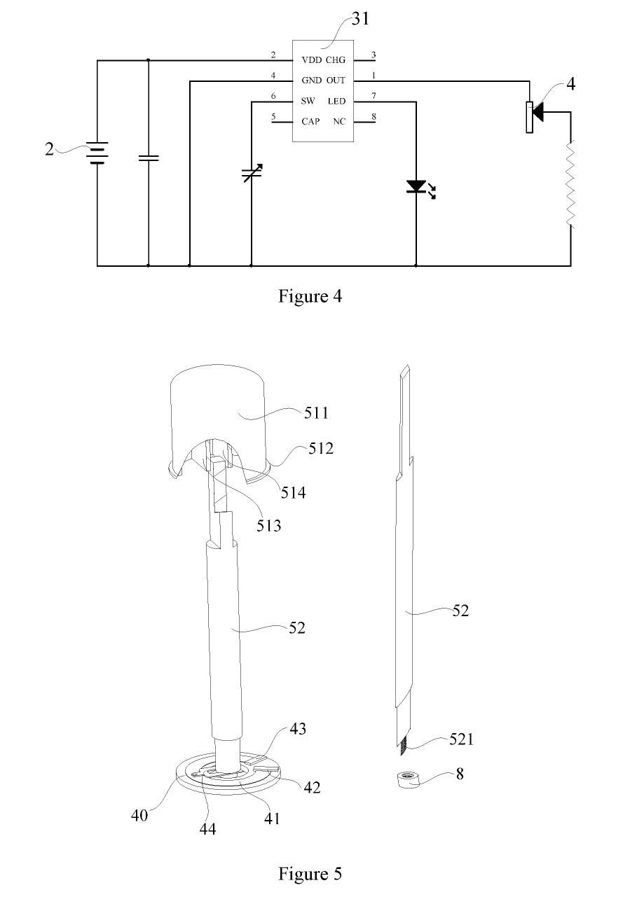

As illustrated in FIG. 4, the control module 3 is electrically connected to the battery 2 while the adjustable resistor 4 is electrically connected to the control module 3, and the control module 3 is defined between the battery 2 and the adjustable resistor 4, the adjustable resistor 4 is configured for adjusting heating power of external circuits (such as the atomizing assembly). Specifically, the adjustable resistor 4 changes a voltage on the external circuit (such as the atomizing assembly), thereby regulating the heating power of the external circuit (such as the atomizing assembly), and thus to achieve a purpose of adjusting smoke amount. In the present embodiment, the control module 3 comprises a control chip 31, a model of the control chip 31 is CT833, and the control module 3 further integrals other circuits, such as an airflow sensor, specifically, as the structure and working principle of the control module 3 is the prior art, they are not introduced here. In other embodiments, the adjustable resistor 4 can be defined between the battery 2 and the control module 3, the output power of the battery 2 can be adjusted by adjusting the adjustable resistor 4 to realize an object to adjust the smoke amount.

The fixing base 6 is roughly cylindrical in shape, it is firmly defined inside the battery sleeve 1, and is arranged at a side opposite to the control module 3, and the fixing base 6 is configured for receiving and fixing the adjustable resistor 4. The adjustable resistor 4 is received inside the fixing base 6, a resistance value of the adjustable resistor 4 which is connected to circuits is adjusted by a rotation of the adjustment mechanism 5, thereby adjusting a voltage and power supplied for the atomizing assembly to realize an adjustment of a size of the smoke amount atomized by the atomizing assembly.

As illustrated in FIG. 5, the adjustable resistor 4 comprises a substrate 40, a carbon film resistor sheet 41, a first conductive sheet 42, a second conductive sheet 43 and a sliding sheet 44. The substrate 40 is a ring, and is received and fixed in the fixing base 6; the carbon film resistor sheet 41 is fixed on an end surface of the substrate 40 which is opposite to the control module 3, and the carbon film resistor sheet 41 is a notched ring, which means that, the carbon film resistor sheet 41 has two ends arranged with a certain distance. The first conductive sheet 42 and the second conductive sheet 43 are firmly connected to two ends of the carbon film resistor sheet 41, and the first conductive sheet 42 and the second conductive sheet 43 are spaced apart from each other. The sliding sheet 44 is a fork shaped structure, one end of a fork shaped opening of the sliding sheet 44 is inserted into and fixed at the adjustment mechanism 5, the other end of the sliding sheet 44 is slidably connected to the carbon film resistor sheet 41, and the sliding sheet 44 can move on the carbon film resistance sheet 41 with a rotation of the adjustment mechanism 5, thereby adjusting a distance between the sliding sheet 44 and the first conductive sheet 42 or the second conductive sheet 43 to adjust the resistance value. The first conductive sheet 42, the second conductive sheet 43 and the sliding sheet 44 are all made of conductive materials.

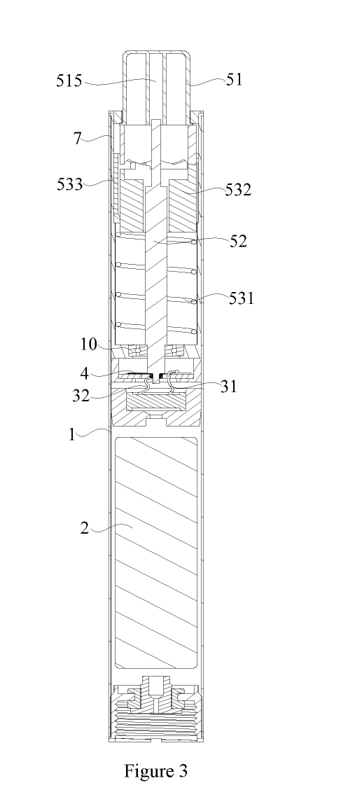

Referring to FIG. 3, the battery assembly further comprises a first conductive wire 31 and a second conductive wire 32 which are electrically connected to a positive electrode and a negative electrode of the battery 2 respectively, and the first conductive wire 31 and the second conductive wire 32 are connected to the control module 3 respectively, which means that, the first conductive wire 31 and the second conductive wire 32 are electrically connected to the positive electrode and the negative electrode of the battery 2 via the control module 3, but the first conductive wire 31 is not connected to the second conductive wire 32. One end of the first conductive wire 31 is electrically connected to the first conductive sheet 42 or the second conductive sheet 43, one end of the second conductive wire 32 is electrically connected to the sliding sheet 44, thus to realize an electrical connection between the control module 3 and the adjustable resistor 4. Namely, one end of the first conductive wire 31 is connected to the control module 3 while the other end is connected to the first conductive sheet 42 or the second conductive sheet 43; one end of the second conductor 31 is connected to the control module 3 while the other end is electrically connected with the sliding sheet 44. When users rotate the adjustment mechanism 5, the sliding sheet 44 rotates together with the adjustment mechanism 5, namely the sliding sheet 44 rotates on the carbon film resistance sheet 41, with a rotation of the sliding sheet 44, the distance between the first conductive sheet 42 or the second conductive sheet 43 and the sliding sheet 44 changes, which means that, a length of the carbon film resistance sheet 41 which is connected to the control module 3 changes as well; as a resistance value of the carbon film resistance sheet 41 is proportional to the length connected to the circuits, the present embodiment adjust the size of the resistance value connected to the circuits by adjusting the length of the carbon film resistance sheet 41 which is connected to the circuits.

A middle part of the substrate 40 is provided with an axial through hole (not labeled), the nut 8 is fixed in the through hole and is rotationally connected to an end of the adjusting mechanism 5 which is close to the fixing base 6. Namely, the adjustment mechanism 5 is rotationally fixed in the nut 8, thereby realizing a rotation of the adjusting mechanism 5 in the battery sleeve 1.

The fixing sleeve 7 is a hollow cylinder, and an inner diameter of the fixing sleeve 7 is slightly smaller than that of the battery sleeve 1m and is sheathed inside the battery sleeve 1. The fixing sleeve 7 is arranged on a side of the fixing base 6 which is opposite the control module 3, and one end of the fixing sleeve 7 extends axially to an end surface of the battery sleeve 1, the other end of the fixing sleeve 7 is abutted against an end surface of the fixing base 6; the adjustment mechanism 5 and the bearing 10 are defined in the fixing sleeve 7, and the adjustment mechanism 5 can slide up and down in the fixing sleeve 7 along an axial direction of the fixing sleeve 7.

The adjustment mechanism 5 is defined at one end of the battery sleeve 1 which is opposite to the battery 2, and is movably sleeved in the battery sleeve 1 and is configured for adjusting a resistance value of the adjustable resistor 4, so as to adjust the output power of the battery assembly by rotating the adjustment mechanism 5 to adjust the adjustable resistor 4. In a normal state, the adjustment mechanism 5 is accommodated within the battery sleeve 1; when an adjustment of the output power of the battery assembly is required by the users, the adjustment mechanism 5 is extended out of the battery sleeve 1 for performing an adjustment of the resistance value of the adjustable resistor 4. Namely, when the output power of the battery assembly is being adjusted, press the adjustment mechanism 5 to enable the adjustment mechanism 5 to extend out of the battery sleeve 1, then rotate the adjustment mechanism 5 to adjust a size of the resistance of the adjustable resistor 4 which is connected to the circuits, thereby performing an adjustment of the output power of the battery, thus to realize an technical object of adjusting a size of the smoke amount of the electronic cigarette.

The adjustment mechanism 5 comprises a button 51, a rotating shaft 52 and an adjustment assembly 53, the button 51 is fixed in an end surface of the battery sleeve 1 which is opposite to the battery 2 and is movable along an axial direction of the battery sleeve 1, namely, the button 51 is fixed inside the battery sleeve 1 to prevent a false operation of pressing the button 51, and to avoid a damage to other parts of the adjustment mechanism 5, so as to improve a service life of the adjustment mechanism 5; while the adjustment of the output power of the battery assembly is required, by adjusting an elastic restoring force of the adjustment assembly 53, the button 51 is extended out of the battery sleeve 1 from an inner part of the battery sleeve 1, so that the users can rotate the button 51, namely, the button 51 can be extended out of or retracted back to the battery sleeve 1 according to requirements of the users.

The rotating shaft 52 which is arranged along the axial direction of the battery sleeve 1 and connected to the button 51 in a sliding manner, and one end of the rotating shaft 52 is slidably connected to the button 51 and rotates with the rotation of the button 51, the other end of the rotating shaft 52 which is opposite to the button 51 is fixedly connected with the sliding sheet 44; when button 51 is rotated, the rotating shaft 52 rotates along with the button 51 and drives the sliding sheet 44 to slide on the carbon film resistor sheet 41 to adjust the length of the carbon film resistor sheet 41 connected into the circuits.

The adjustment assembly 53 is sleeved outside the rotating shaft 52 and is arranged between the button 51 and the adjustable resistor 4, and the adjustment assembly 53 is in an elastic compression state within the battery sleeve 1 for enabling the button 51 to be extended out of or retracted back to the battery sleeve 1. Specifically, when the button 51 is pressed, the button 51 is ejected by the adjustment assembly 53, and the button 51 is axially limited at a first position of the battery sleeve 1, then the rotating shaft 52 is driven to rotate together with the button 51 by rotating the button 51 to adjust a resistance value of the adjustable resistance 4. When the button 51 is pressed again, the button 51 is retracted by the adjustment assembly 53 and is limited in a second position of the battery sleeve 1, then the button 51 is fully retracted in the battery sleeve 1 for preventing a false operation of a touch of the button 51.

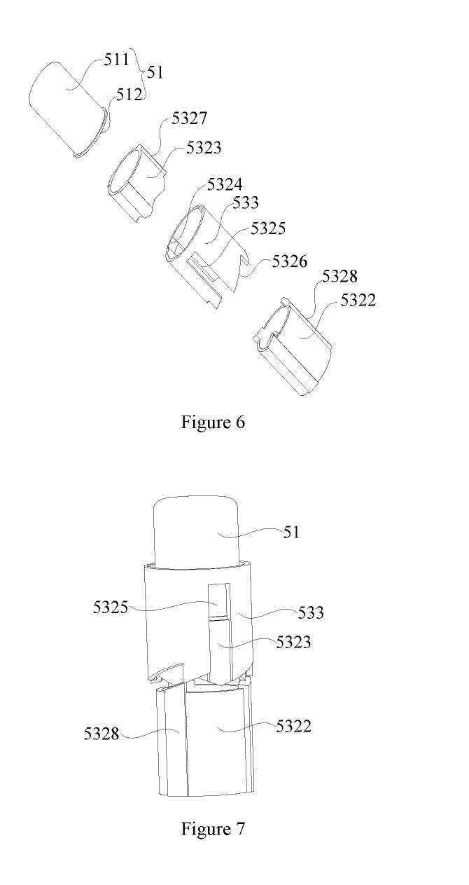

As shown in FIG. 6, button 51 is generally a cap, a periphery of the button 51 is outwardly extended in a radial direction of the button 51 to form a flange 512, a protrusion (not labeled) is formed by an inwardly radial extension inside an end surface of the battery sleeve 1. When the button 51 is limited at the first position, the flange 512 is abutted against an end surface of the protrusion, presently the button 51 is partly extended out of the battery sleeve 1 to facilitate the user to operate a rotation of the button 51; when the button 51 is limited at the second position, an end of the button 51 which is opposite to the flange 512 is abutted against an inner side wall of the protrusion, then the button 51 is fully retracted in the battery sleeve 1 for preventing a false operation of the button 51.

A positioning ring 9 is defined at an end surface of the battery sleeve 1 which is close to the button 51, the protrusion is a part of the positioning ring 9 sleeved in the battery sleeve 1, the protrusion is configured for enabling the end surface of the protrusion to abut against the end surface of the flange 512 when the button 51 is limited at the first position to prevent the button 51 from falling out of the battery sleeve 1; and enabling an inner side wall of the protrusion to abut against and be fixed at an end of the button 51 which is opposite to the flange 512 (i.e an end of the body portion 511) when the button 51 is limited at the second position, so as to limit the button 51 inside the battery sleeve 1.

The button 51 comprises a body portion 511, a flange 512 which is formed by outwardly extending from a periphery of the body portion 511 in a radial direction of body portion 511, and a receiving part 515 which is arranged along an axial direction of the button 51, in a normal state, an outer side wall of the body portion 511 is abutted against an inner side wall of the protrusion of the positioning ring 9 to enable the button 51 to be limited inside the battery sleeve 1. The receiving part 515 is configured for the rotating shaft 52 to axially slid in the button 51, in the present embodiment, a first fixing panel 513 and a second fixing panel 514 which are arranged in parallel are extended axially along and defined inside the body portion 511, shapes and sizes of the first fixing panel 513 and the second fixing panel 514 are totally the same, and the first fixing panel 513 and the second fixing panel 514 are both extended from a bottom end of the body portion 511 to a side of the flange 512, the receiving part 515 is formed at a gap between the first fixing panel 513 and the second fixing panel 514. When the button 51 moves in the battery sleeve 1, the rotating shaft 52 is also sliding in the receiving part 515; when the button 51 is rotated, the rotating shaft 52 is rotated together with the button 51.

The rotating shaft 52 is generally a long rod, one end of the rotating shaft 52 is slidably connected to the button 51 while the other end is defined with an external thread 521, and an axial length of the rotating shaft 52 is generally the same with that of the fixing sleeve 7. The end of the rotating shaft 52 which is slidably connected to the button 51 is roughly a rectangular rod, and a cross section of the end surface is rectangular, this end of the rotating shaft 52 is clamped in the receiving part 515 which is arranged between the first fixing panel 513 and the second fixing panel 514, and the rotating shaft 52 can axially slid in the receiving part 515 to realize that the button 51 can be extended out of the battery sleeve 1 for the inner part of the battery sleeve 1 or retracted back to the battery sleeve 1. Further, a length of the end surface of the rotating shaft 52 which is a rectangular is wider than its width, as the length of the rotating shaft 52 is larger than a width of the receiving part 515, when the button 51 is rotated, the rotating shaft 52 is rotated with a rotation of the button 51 to adjust a size of a resistance value of the adjustable resistor 4. The end of the rotating shaft 52 which is defined with the external thread 521 has a threaded connection with the nut 8, and clamps and fixes the sliding sheet 44 between the external thread 521 and the nut 8, when the button 51 is rotated, the rotating shaft 52 is rotated in the nut 8, and enables the sliding sheet 44 to rotate on the carbon film resistor sheet 41 to realize the object of adjusting a size of the resistance value. In the present embodiment, one end of the second conductive wire 32 is connected to the nut 8, and as the but 8 is firmly touched with the sliding sheet 44, thereby realizing an electrical connection between the second conductive wire 32 and the sliding sheet 44.

The bearing 10 is clamped in an end surface of the fixing sleeve 7 which is close to the fixing base 6, and the rotating shaft 52 passes through the bearing 10 and then connected to the nut 8. When the rotating shaft 52 is rotated in the battery sleeve 1, the bearing 10 can reduce a friction coefficient between the rotating shaft 52 and the fixed sleeve 7, it facilitates a rotation of the rotating shaft 52, and increases a service life of the rotating shaft 52.

The adjustment assembly 53 comprises a positioning cylinder 533 firmly sleeved in the battery sleeve 1, a sliding cylinder 532 capable of sliding in the positioning cylinder 533, and an elastic member 531 for providing an elastic force for the sliding cylinder 532, the button 51, the sliding cylinder 532 and the elastic member 531 are abutted successively in the battery sleeve 1. The sliding cylinder 532 comprises a toothed cylinder 5323 which is slidably sleeved inside one end of the positioning cylinder 533, and a rotating cylinder 5322 which is slidably sleeved at the other end of the positioning cylinder 533, and the toothed cylinder 5323 is abutted between the button 51 and the rotating cylinder 5322, the elastic member 531 is abutted against the rotating cylinder 5322, and provides an elastic restoring force for the rotating cylinder 5322.

The toothed cylinder 5323 is a hollow cylinder which is defined in the positioning cylinder 533, and is abutted between the button 51 and the rotating cylinder 5322. At least two projections 5327 are arranged with intervals and defined on an outer side wall of the toothed cylinder 5323, the projections 5327 are axially extended along the toothed cylinder 5323, and their axial distances are equal to that of the toothed cylinder 5323; meanwhile, an end surface of the toothed cylinder 5323 which is opposite to the button 51 is a toothed end surface, namely, the end surface of the toothed cylinder 5323 which is close to the rotating cylinder 5322 is saw tooth. In the present embodiment, quantity of the projections 5327 is three, and the three projections 5327 are defined with equal intervals, understandably, quantity of the projections 5327 is not limited to three.

The positioning cylinder 533 is fixed on an inner side wall of the battery sleeve 1, and cannot move in the battery sleeve 1. An internal diameter of the positioning cylinder 533 is slightly larger than that of the toothed cylinder 5323, an axial length of the positioning cylinder 533 is larger than that of the toothed cylinder 5323 as well. Butt joint grooves 5324 and notches 5325 which are communicated mutually are defined on the positioning cylinder 533, the butt joint grooves 5324 are defined by depressions at an end surface of the positioning cylinder 533 which is close to the button 51, and are configured for the projections 5327 to insert into; the notches 5325 are formed by extending on a side wall of the positioning cylinder 533 along a bottom end of the butt joint grooves 5324, and the notches 5325 extend until another end of the positioning cylinder 533 which is opposite to the butt joint grooves 5324. Chutes 5326 which are communicated with the notches 5325 are arranged on an end surface of the positioning cylinder 533 which is close to the notches 5325, a bottom wall of the chutes 5326 inclines upward along a side wall of the notches 5325, quantity of the chutes 5326 is equal to that of the notches 5325. In the present embodiment, quantities of the butt joint grooves 5324, the notches 5325 and the chutes 5326 are three.

The rotating cylinder 5322 is a hollow cylinder as well, and an outer side wall of the rotating cylinder 5322 is also provided with convex parts 5328 defined with intervals, the convex parts 5328 are convexly defined on an outer side wall of the rotating cylinder 5322, and extends along an axial direction of the rotating cylinder 5322, meanwhile, quantity of the convex parts 5328 is respectively equal to that of the projections 5327, the convex parts 5328 and the projections 5327 are correspondingly arranged. A part of an end surface of the rotating cylinder 5322 which is close to the positioning cylinder 533 is an inclined end surface, and an axial length of the convex parts 5328 is larger than that of the rotating cylinder 5322, the inclined end surface is an end surface of the convex parts 5328 which is close to the positioning cylinder 533, and the inclined end surface is convex out of an end surface of the rotating cylinder 5322 which is close to the positioning cylinder 533, namely, the inclined end surface of the convex parts 5328 is higher than an end surface of the rotating cylinder 5322 with a certain distance. Further, an inclined direction of the inclined end surface is adapted to the chutes 5326 to enable the inclined end surface to be abutted in the chutes 5326.

In the present embodiment, the elastic member 531 is a spring which is sleeved on an outside surface of the rotating shaft 52 and is abutted between an end surface of the fixing sleeve 7 and an end surface of the rotating cylinder 5322, and provides the elastic restoring force for the rotating cylinder 5322 and the toothed cylinder 5323. Meanwhile a distance of the elastic member 531 axially moving in the battery sleeve 1 is equal to a distance of the rotating shaft 52 sliding in the receiving part 515.

When pressing the button 51, the toothed end surface is abutted against the inclined end surface of the rotating cylinder 5322, the button 51 pushes the toothed cylinder 5323 together with the rotating cylinder 5322 to slide downward and press the elastic member 531, when sliding to a position that the end surface of the rotating cylinder 5322 is slid out of the chutes 5326, a rotation is happened on the rotating cylinder 5322 and the rotating cylinder 5322 is sheathed in notch 5325 of the positioning cylinder 533, and an elastic force for upward sliding the toothed cylinder 5323 and the rotating cylinder 5322 is provided under an action of the elastic restoring force of the elastic member 531, thereby the button 51 is limited in the first position; presently, the button 51 is extended out of the battery sleeve 1, the users can adjust a resistance value of the adjustable resistor 4 by rotating the button 51. When the button 51 is pressed again, the button 51 pushes the toothed cylinder 5323 together with the rotating cylinder 5322 to slide downward and press the elastic member 531, when the toothed end surface is abutted against the inclined end surface, a rotation of the rotating cylinder 5322 happens in the battery sleeve 1, when the rotating cylinder 5322 rotates to a position which enables the inclined end surface of the rotating cylinder 5322 to be clamped in the chutes 5326, the button 51 is retracted back to the second position, presently the button 51 is totally accommodated in the battery sleeve 1 to prevent a phenomenon of adjusting the adjustable resistor 4 by a false operation.

As shown in FIG. 2, the button 51 in the present embodiment is sleeved inside the battery sleeve 1, when users do not smoke the electronic cigarette or when the electronic cigarette is in a transportation, it can avoid an incorrect operation to press the button 51, thus avoiding the phenomenon of adjusting the adjustable resistor 4 by a false operation. As illustrated in FIG. 7, when the users need to adjust the output power of the battery assembly, press the button 51, the button 51 pushes the toothed cylinder 5323 together with the rotating cylinder 5322 to slide downward and press the elastic member 531, when sliding to a position that the inclined end surface of the convex parts 5328 is slid out of the chutes 5326, and when the toothed end surface is abutted against the inclined end surface, a rotation is happened on the rotating cylinder 5322 in the battery sleeve 1 under a push force of the toothed end surface, and the rotating cylinder 5322 rotates to the notches 5323 along the chutes 5326; then the rotating cylinder 5322 pushes the toothed cylinder 5323 to slide upward along the notches 5325 under an action of the elastic restoring force of the elastic member 531, and the button 51 is extended out of the battery sleeve 1, as an effect of the protrusion on the positioning ring 9, the button 51 is prevented from falling out of the battery sleeve 1.

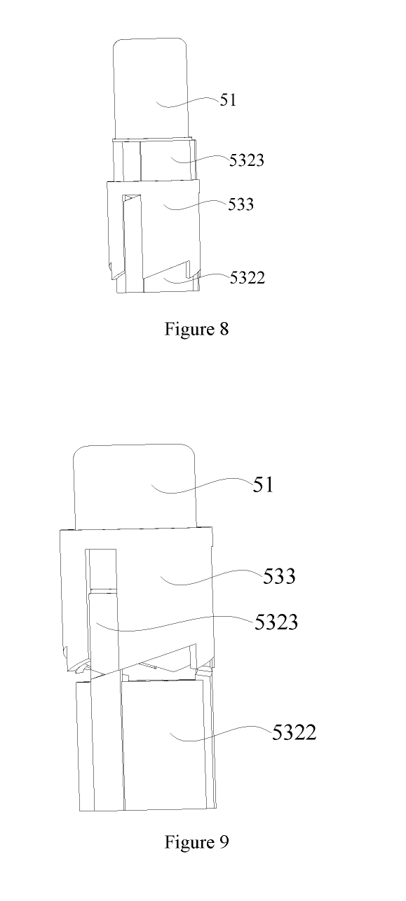

As shown in FIG. 8 which is a structural schematic diagram of the button 51 extending out of the battery sleeve 1, then the users can rotate the button 51 to realize an adjustment of a size of the resistance value of the adjustable resistor 4. Specifically, when the button 51 is rotated, the rotating shaft 52 is rotated together with a rotation of the button 51, thereby driving the sliding sheet 44 with an end fixed on the rotating shaft 52 rotates on the carbon film resistor sheet 41, then a length between the first conductive sheet 42 or the second conductive sheet 43 and the sliding sheet 44 is adjusted, namely, it realizes an adjustment of the size of the resistance value connected to the control module 3, and achieves the object of adjusting a size of the resistance value of the adjustable resistor 4, thereby adjusting the output power of the battery 2 and satisfying requirements of different clients. Meanwhile, the users can smoke the electronic cigarette while turning the button 51 to adjust the output power of the battery assembly until the output power of the battery assembly satisfies the requirements of the users. This method is simple in operating and can satisfy different requirements of the smoke amount of different customers.

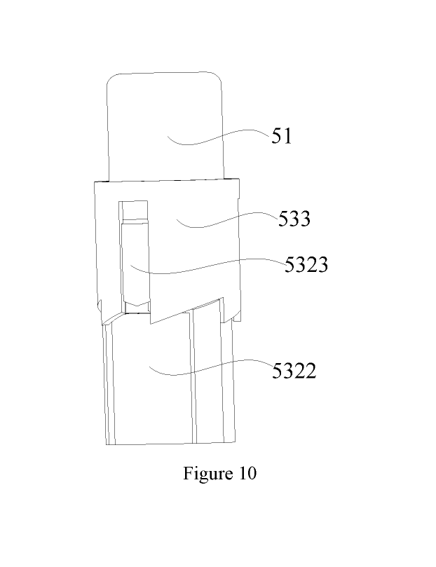

It can be seen from FIG. 9 and FIG. 10 that the button 51 can be pressed again to make it retracted back to the battery sleeve 1 to prevent a rotation of the button 51 caused by a false operation of the users, when the users have no needs to adjust the smoke amount. Specifically, when the button 51 is pressed again, the button 51 pushes the toothed cylinder 5323 together with the rotating cylinder 5322 to slide downward and press the elastic member 531, when sliding to a position that the inclined end surface of the convex parts 5328 is slid out of the notches 5325, and when the toothed end surface is abutted against the inclined end surface, a rotation of the rotating cylinder 5322 is happened in the battery sleeve 1 under a push force of the toothed end surface of the toothed cylinder 5323, and the rotating cylinder 5322 rotates along the chutes 5326 until that the inclined end surface of the convex parts 5328 is clamped the chutes 5326, thereby the rotating cylinder 5322 is abutted against and fixed with the positioning cylinder 533, then the button 51 is retracted in the battery sleeve 1. It prevents a change of the smoke amount caused by an accident rotation of the button 51 during a smoking or a phenomenon of rotating the button 51 by a false operation when the users do not need to smoke the electronic cigarette.

The battery assembly of the present embodiment, by defining an adjustable resistor 4 which is connected to the control module 3 to realize an adjustment of an output power of the battery assembly, and a resistance value of the adjustable resistor 4 can be adjusted by the adjustment mechanism 5, users only need to press the adjustment mechanism 5 to make the adjustment mechanism 5 extend out of the battery sleeve 1, then rotate the adjustment mechanism 5 to adjust the resistance value of adjustable resistor 4, thereby the output power of the battery assembly is adjusted, and users experience is improved. Meanwhile, when users do not need to smoke the electronic cigarette, the adjustment mechanism 5 is accommodated within the battery sleeve 1, preventing a change of the smoke volume caused by a false operation of the users, and a phenomenon that the adjustment mechanism 5 is careless to be pressed during a transportation; and the adjustment method is an easy operation, it is only need to press or/and rotate the adjustment mechanism 5, thus it is convenient and fast, and user experience is improved.

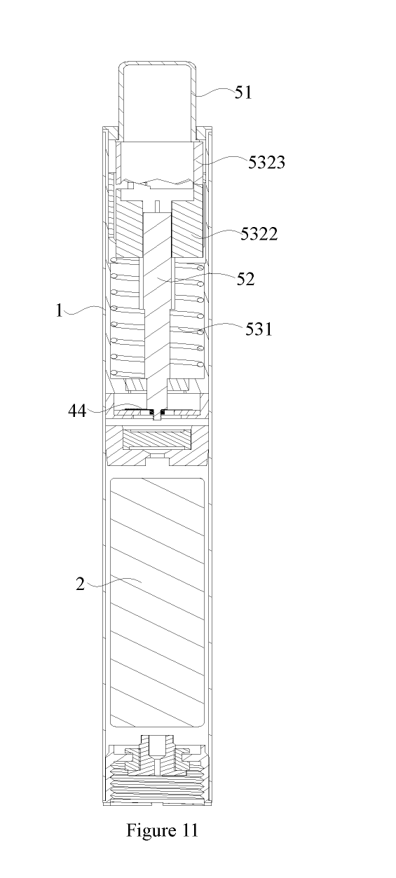

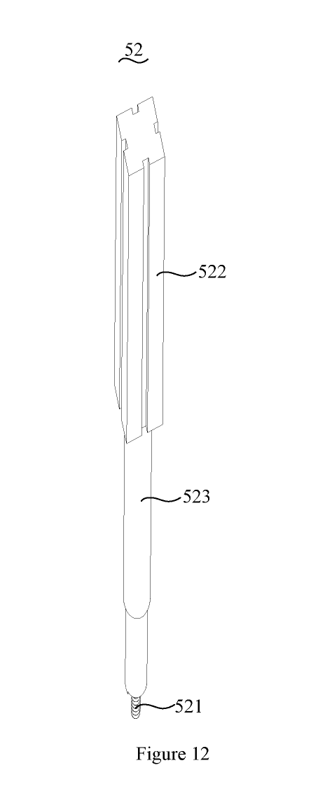

As shown in FIG. 11 and FIG. 12, a battery assembly provided by the second embodiment of the present invention, a difference between the second embodiment and the first embodiment is that a configuration of the rotating shaft 52 is different with that of the first embodiment. One end of the rotating shaft 52 of the present embodiment is sleeved in the rotating cylinder 5322, while the other end of the rotating shaft 52 is fixedly connected to the sliding sheet 44, and the rotating shaft 52 can rotate in the battery sleeve 1 with a rotation of the rotating cylinder 5322, thereby realizing an automatic adjustment of a resistance value of the adjustable resistor. Namely, when the button 51 is pressed, the rotating shaft 52 rotates together with the rotating cylinder 5322 and drives the sliding sheet 44 to slide on the carbon film resistor sheet 41, then a length of the carbon film resistor sheet 41 connected into circuits is adjusted.

The rotating shaft 52 comprises a rectangular block 522 and a cylinder 523, and the rectangular 522 and the cylinder 523 are integrally formed. A cross section of the end surface of the rectangular block 522 is rectangular, the rectangular block 522 is sleeved in the rotating cylinder 5322, and a length of the end surface of the rectangular block 522 is larger than its width, when the rotating cylinder 5322 is rotated in the battery sleeve 1, the rotating shaft 52 is rotated with a rotation of the rotating cylinder 5322 to adjust a size of a resistance value of the adjustable resistor 4. An elastic member 531 is sleeved on the cylinder 523, and an end of the cylinder 523 which is opposite to the rectangular block 522 is defined with the external thread 521, the external thread 521 has a threaded connection with the nut 8, and it clamps and fixes the sliding sheet 44 between the external thread 521 and the nut 8, when the rotating shaft 52 is rotated with a rotation of the rotating cylinder 5322, the rotating shaft 52 is rotated in the nut 8, and enables the sliding sheet 44 to rotate on the carbon film resistor sheet 41 to realize the object of adjusting a size of the resistance value.

In the battery assembly of the present embodiment, when the button 51 is pressed, the toothed end surface is abutted against the inclined end surface of the rotating cylinder 5322, the button 51 pushes the toothed cylinder 5323 together with the rotating cylinder 5322 to slide downward and press the elastic member 531, when sliding to a position that the end surface of the rotating cylinder 5322 is slid out of the chutes 5326, the rotating cylinder 5322 together with the rotating shaft 52 rotates in the battery sleeve 1, when the rotating cylinder 5322 rotates to a position which enables the inclined end surface of the rotating cylinder 5322 to be sheathed in notches 5325 of the positioning cylinder 533, an elastic force for upward sliding the toothed cylinder 5323 and the rotating cylinder 5322 is provided under an action of the elastic restoring force of the elastic member 531, thereby the button 51 is extended out of the battery sleeve 1; as the rotating shaft 52 can rotate together with the rotating cylinder 5322 in the battery sleeve 1, it realizes an automatic adjustment of a resistance value of the adjustable resistor 4 by only pressing the button 51, then the object of adjusting the output power of the battery assembly can be achieved. When the button 51 is pressed again, the button 51 pushes the toothed cylinder 5323 together with the rotating cylinder 5322 to slide downward and press the elastic member 531, when the toothed end surface is abutted against the inclined end surface, a rotation of the rotating cylinder 5322 happens in the battery sleeve 1, when the rotating cylinder 5322 rotates to a position which enables the inclined end surface of the rotating cylinder 5322 to be clamped in the chutes 5326, the button 51 is retracted back to the second position, presently the button 51 is totally accommodated in the battery sleeve 1 to prevent a phenomenon of adjusting the adjustable resistor 4 by a false operation.

In the battery assembly of the present embodiment, as the rotating shaft 52 can be rotated together with a rotation of the rotating cylinder 5322, when the resistance value of the adjustable resistor 4 is needed to be adjusted, it is only needed to press the button 51, then that the rotating shaft 52 rotates together with a rotation of the rotating cylinder 5322 in the battery sleeve 1 can be realized, thereby the resistance value of the adjustable resistor 4 can be automatically adjusted, this operation is easy, convenient, and improves the users experience. When the button 51 is pressed again, the button 51 is retracted back to the battery sleeve 1 to prevent a phenomenon of adjusting the adjustable resistor 4 by a false operation.

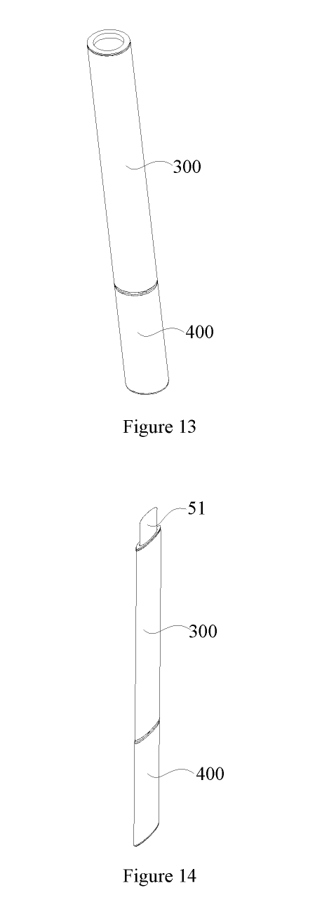

It can be illustrated from FIG. 13 and FIG. 14 that the present invention further provides an electronic cigarette, comprising a battery assembly 300 and an atomizing assembly 400 which are connected to each other mutually, the structure and working principle of the atomizing assembly 400 are the prior arts, and will not be explained here, the battery assembly 300 can be any one of the first embodiment or the second embodiment.

As shown in FIG. 13, when the electronic cigarette is in a normal state, the button 51 is accommodated in the sleeve of the battery assembly 300 to prevent defects of pressing or rotating the button 51 caused by a false operation. It can be seen from FIG. 14 that the button 51 is extended out of the battery sleeve of the battery assembly 300 when the electronic cigarette is in a smoking state and in a state that the smoke amount of the cigarette oil atomization of the atomizing assembly 400 is required to be adjusted, and the button 51 is rotated to adjust the smoke amount to satisfy requirements of different users. Specific structure and working principle are not explained here, and the electronic cigarette of the present invention can achieve the technical effects of the above battery assembly.

While the embodiments of the present application are described with reference to the accompanying drawings above, the present application is not limited to the above-mentioned specific implementations. In fact, the above-mentioned specific implementations are intended to be exemplary not to be limiting. In the inspiration of the present application, those ordinary skills in the art can also make many modifications without breaking away from the subject of the present application and the protection scope of the claims. All these modifications belong to the protection of the present application.

1. A battery assembly configured for forming an electronic cigarette in combination with an atomizing assembly, wherein the battery assembly comprises:
a battery sleeve (1), a battery (2) sleeved within the battery sleeve (1), a control module (3) electrically connected to the battery (2), and an adjustable resistor (4) electrically connected to the control module (3);
wherein one end of the battery sleeve (1) is movably sleeved with an adjustment mechanism (5) configured for adjusting the adjustable resistor (4), the adjustable resistor (4) is adjusted by rotating the adjustment mechanism (5), thereby output power of the battery assembly is adjusted; and
wherein the adjustment mechanism (5) is accommodated within the battery sleeve (1) in a normal state; when an adjustment of the output power of the battery assembly is required, the adjustment mechanism (5) is extended out of the battery sleeve (1) for the adjustment to be performed.

2. The battery assembly according to claim 1, wherein the adjustment mechanism (5) comprises a button (51) which is movable along an axial direction of the battery sleeve (1), a rotating shaft (52) which is arranged along the axial direction of the battery sleeve (1) and connected to the button (51) in a sliding manner, and an adjustment assembly (53) which is sleeved outside the rotating shaft (52) and is arranged between the button (51) and the adjustable resistor (4);
wherein the button (51) is configured for being ejected by the adjustment assembly (53) to make the button (51) is axially limited at a first position of the battery sleeve (1) when the button (51) is pressed, the rotating shaft (52) is driven to rotate together with the button (51) by rotating the button (51) to adjust a resistance value of the adjustable resistance (4); and
wherein the button (51) is configured for being retracted by the adjustment assembly (53) and is limited in a second position of the battery sleeve (1) when the button (51) is pressed again.

3. The battery assembly according to claim 2, wherein the adjustment assembly (53) comprises a positioning cylinder (533) firmly sleeved in the battery sleeve (1), a sliding cylinder (532) slidably disposed in the positioning cylinder (533), and an elastic member (531) for providing an elastic force for the sliding cylinder (532); the button (51), the sliding cylinder (532) and the elastic member (531) are abutted successively;
wherein a periphery of the button (51) is outwardly extended in a radial direction of the button (51) to form a flange (512), a protrusion is formed by an inwardly radial extension inside an end surface of the battery sleeve (1); and
wherein the flange (512) is abutted against an end surface of the protrusion when the button (51) is in the first position; an end of the button (51) which is opposite to the flange (512) is abutted against an inner side wall of the protrusion when the button (51) is in the second position.

4. The battery assembly according to claim 3, wherein the sliding cylinder (532) comprises a toothed cylinder (5323) which is slidably sleeved inside one end of the positioning sleeve (533), and a rotating cylinder (5322) which is slidably sleeved at the other end of the positioning cylinder (533), and the toothed cylinder (5323) is abutted between the button (51) and the rotating cylinder (5322);
wherein an end surface of the toothed cylinder (5323) which is opposite to the button (51) is a toothed end surface, chutes (5326) is arranged on an end surface of the positioning sleeve (533) which is close to the rotating cylinder (5322), a part of an end surface of the rotating cylinder (5322) which is close to the positioning cylinder (533) is an inclined end surface;
wherein the toothed end surface is abutted against the inclined end surface when the button (51) is pressed, the button (51) is configured to push the toothed cylinder (5323) together with the rotating cylinder (5322) to slide downward and press the elastic member (531), when sliding to a position that the end surface of the rotating cylinder (5322) is slid out of the positioning cylinder (533), a rotation of the rotating cylinder (5322) is happened and the rotating cylinder (5322) is sheathed in the positioning cylinder (533), and an elastic force for upward sliding the toothed cylinder (5323) and the rotating cylinder (5322) is provided under an action of an elastic restoring force of the elastic member (531), thereby the button (51) is limited in the first position;
when the button (51) is pressed again, the button (51) is further configured to push the toothed cylinder (5323) together with the rotating cylinder (5322) to slide downward and press the elastic member (531), when the rotating cylinder (5322) rotates to a position which enables the inclined end surface of the rotating cylinder (5322) to be clamped in the chutes (5326), the button (51) is retracted back to the second position.

5. The battery assembly according to claim 4, wherein at least two projections (5327) are arranged with intervals and defined on an outer side wall of the toothed cylinder (5323);
wherein butt joint grooves (5324) for the projections (5327) to insert into are defined at an end surface of the positioning cylinder (533) which is close to the button (51), and notches (5325) are defined on a side wall of the positioning cylinder (533) and extended along the butt joint grooves (5324), the chutes (5326) and the notches (5325) are communicated with each other and are arranged on an end surface of the positioning cylinder (533) which is close to the notches (5325), and quantity of the chutes (5326) is the same with quantity of the notches (5325); and
wherein an outer side wall of the rotating cylinder (5322) is provided with convex parts (5328) defined with intervals, quantity of the convex parts (5328) is equal to quantity of the projections (5327), the convex parts (5328) and the projections (5327) are correspondingly arranged, the inclined end surface is an end surface of the convex parts (5328) which is close to the positioning cylinder (533), and the inclined end surface is convex out of an end surface of the rotating cylinder (5322) which is close to the positioning cylinder (533).

6. The battery assembly according to claim 5, wherein the button (51) comprises a receiving part (515) which is an inner hollow part and is defined along an axial direction of the button (51), the receiving part (515) is configured for the rotating shaft (52) to axially slide, and a distance of the rotating shaft (52) sliding in the receiving part (515) is equal to a distance of the elastic member (531) axially moving in the battery sleeve (1).

7. The battery assembly according to claim 5, wherein a positioning ring (9) is defined at an end surface of the battery sleeve (1), the protrusion is a part of the positioning ring (9) sleeved in the battery sleeve (1).

8. The battery assembly according to claim 5, wherein the adjustable resistor (4) comprises a carbon film resistor sheet (41), a first conductive sheet (42) , a second conductive sheet (43), and a sliding sheet (44) which is slidably connected to the carbon film resistor sheet (41), the first conductive sheet (42) and the second conductive sheet (43) is fixed at two ends of the carbon film resistor sheet (41) respectively, one end of the rotating shaft (52) which is opposite to the button (51) is firmly connected with the sliding sheet (44), and the sliding sheet (44) is configured to move on the carbon film resistance sheet (41) with a rotation of the rotating shaft (52).

9. A battery assembly configured for forming an electronic cigarette in combination with an atomizing assembly, wherein the battery assembly comprises:
a battery sleeve (1), a battery (2) sleeved within the battery sleeve (1), a control module (3) electrically connected to the battery (2), and an adjustable resistor (4) electrically connected to the control module (3);
wherein one end of the battery sleeve (1) is movably sleeved with an adjustment mechanism (5) configured for adjusting the adjustable resistor (4), the adjustable resistor (4) is adjusted by pressing the adjustment mechanism (5), and output power of the battery assembly is thereby adjusted;
wherein the adjustment mechanism (5) comprises a button (51) which is movable along an axial direction of the battery sleeve (1), a rotating shaft (52) which is arranged along the axial direction of the battery sleeve (1) and connected to the adjustable resistor (4) in a sliding manner, and an adjustment assembly (53) which is sleeved outside the rotating shaft (52) and is arranged between the button (51) and the adjustable resistor (4);
wherein the adjustment assembly (53) comprises a positioning cylinder (533) firmly sleeved in the battery sleeve (1), a toothed cylinder (5323) which is slidably sleeved in one end of the positioning cylinder (533), a rotating cylinder (5322) which is slidably sleeved on the other one end of the positioning cylinder (533), and an elastic member (531) for providing an elastic force for the rotating cylinder (5322) and the toothed cylinder (5323), the button (51), the toothed cylinder (5323), the rotating cylinder (5322) and the elastic member (531) are abutted successively;
wherein a periphery of the button (51) is outwardly extended in a radial direction of the button (51) to form a flange (512), a protrusion is formed by an inwardly radial extension inside an end surface of the battery sleeve (1);
wherein an end surface of the toothed cylinder (5323) which is opposite to the button (51) is a toothed end surface, chutes (5326) are arranged on an end surface of the positioning sleeve (533) which is close to the rotating cylinder (5322), an end surface of the rotating cylinder (5322) which is close to the positioning cylinder (533) is an inclined end surface;
wherein the toothed end surface is abutted against the inclined end surface when the button (51) is pressed, the button (51) is configured to push the toothed cylinder (5323) together with the rotating cylinder (5322) to slide downward and press the elastic member (531), when sliding to a position that the end surface of the rotating cylinder (5322) is slid out of the positioning cylinder (533), the rotating cylinder (5322) is configured to drive the rotating shaft (52) to rotate together and is sheathed in the positioning cylinder (533), and an elastic force for upward sliding the toothed cylinder (5323) and the rotating cylinder (5322) is provided under an action of an elastic restoring force of the elastic member (531), thereby the button (51) is limited in the first position;
when the button (51) is in the first position, the flange (512) is abutted against an end surface of the protrusion
when the button (51) is pressed again, the button (51) is further configured to push the toothed cylinder (5323) together with the rotating cylinder (5322) to slide downward and press the elastic member (531), when the rotating cylinder (5322) rotates to a position which enables the inclined end surface of the rotating cylinder (5322) to be clamped in the chutes (5326), the button (51) is retracted back to the second position, when the button (51) is in the second position, an end of the button (51) which is opposite to the flange (512) is abutted against an inner side wall of the protrusion.

10. An electronic cigarette comprising a battery assembly (300) and an atomizing assembly (400) which are connected to each other mutually, wherein the battery assembly comprises:
a battery sleeve (1), a battery (2) sleeved within the battery sleeve (1), a control module (3) electrically connected to the battery (2), and an adjustable resistor (4) electrically connected to the control module (3);
wherein one end of the battery sleeve (1) is movably sleeved with an adjustment mechanism (5) configured for adjusting the adjustable resistor (4), the adjustable resistor (4) is adjusted by rotating the adjustment mechanism (5), and output power of the battery assembly is thereby adjusted; and
wherein the adjustment mechanism (5) is accommodated within the battery sleeve (1) in a normal state; when an adjustment of the output power of the battery assembly is required, the adjustment mechanism (5) is extended out of the battery sleeve (1) for the adjustment to be performed.

11. The battery assembly according to claim 10, wherein the adjustment mechanism (5) comprises a button (51) which is movable along an axial direction of the battery sleeve (1), a rotating shaft (52) which is arranged along the axial direction of the battery sleeve (1) and connected to the button (51) in a sliding manner, and an adjustment assembly (53) which is sleeved outside the rotating shaft (52) and is arranged between the button (51) and the adjustable resistor (4);
wherein the button (51) is configured for being ejected by the adjustment assembly (53), and the button (51) is axially limited at a first position of the battery sleeve (1) when the button (51) is pressed, the rotating shaft (52) is driven to rotate together with the button (51) by rotating the button (51) to adjust a resistance value of the adjustable resistance (4); and
wherein the button (51) is configured for being retracted by the adjustment assembly (53) and is limited in a second position of the battery sleeve (1) when the button (51) is pressed again.

12. The battery assembly according to claim 11, wherein the adjustment assembly (53) comprises a positioning cylinder (533) firmly sleeved in the battery sleeve (1), a sliding cylinder (532) slidably disposed in the positioning cylinder (533), and an elastic member (531) for providing an elastic force for the sliding cylinder (532); the button (51), the sliding cylinder (532) and the elastic member (531) are abutted successively;
wherein a periphery of the button (51) is outwardly extended in a radial direction of the button (51) to form a flange (512), a protrusion is formed by an inwardly radial extension inside an end surface of the battery sleeve (1); and
wherein the flange (512) is abutted against an end surface of the protrusion when the button (51) is in the first position; an end of the button (51) which is opposite to the flange (512) is abutted against an inner side wall of the protrusion when the button (51) is in the second position.

13. The battery assembly according to claim 12, wherein the sliding cylinder (532) comprises a toothed cylinder (5323) which is slidably sleeved inside one end of the positioning sleeve (533), and a rotating cylinder (5322) which is slidably sleeved at the other end of the positioning cylinder (533), and the toothed cylinder (5323) is abutted between the button (51) and the rotating cylinder (5322);
wherein an end surface of the toothed cylinder (5323) which is opposite to the button (51) is a toothed end surface, chutes (5326) are arranged on an end surface of the positioning sleeve (533) which is close to the rotating cylinder (5322), a part of an end surface of the rotating cylinder (5322) which is close to the positioning cylinder (533) is an inclined end surface;
wherein the toothed end surface is abutted against the inclined end surface when the button (51) is pressed, the button (51) is configured to push the toothed cylinder (5323) together with the rotating cylinder (5322) to slide downward and press the elastic member (531), when sliding to a position that the end surface of the rotating cylinder (5322) is slid out of the positioning cylinder (533), a rotation of the rotating cylinder (5322) is happened and the rotating cylinder (5322) is sheathed in the positioning cylinder (533), and an elastic force for upward sliding the toothed cylinder (5323) and the rotating cylinder (5322) is provided under an action of the elastic restoring force of the elastic member (531), thereby the button (51) is limited in the first position;
when the button (51) is pressed again, the button (51) is further configured to push the toothed cylinder (5323) together with the rotating cylinder (5322) to slide downward and press the elastic member (531), when the rotating cylinder (5322) rotates to a position which enables the inclined end surface of the rotating cylinder (5322) to be clamped in the chutes (5326), the button (51) is retracted back to the second position.

14. The battery assembly according to claim 13, wherein at least two projections (5327) are arranged with intervals and defined on an outer side wall of the toothed cylinder (5323);
wherein butt joint grooves (5324) for the projections (5327) to insert into are defined at an end surface of the positioning cylinder (533) which is close to the button (51), and notches (5325) are defined on a side wall of the positioning cylinder (533) and extended along the butt joint grooves (5324), the chutes (5326) and the notches (5325) are communicated with each other and are arranged on an end surface of the positioning cylinder (533) which is close to the notches (5325), and quantity of the chutes (5326) is the same with quantity of the notches (5325); and
wherein an outer side wall of the rotating cylinder (5322) is provided with convex parts (5328) defined with intervals, quantity of the convex parts (5328) is equal to quantity of the projections (5327), the convex parts (5328) and the projections (5327) are correspondingly arranged, the inclined end surface is an end surface of the convex parts (5328) which is close to the positioning cylinder (533), and the inclined end surface is convex out of an end surface of the rotating cylinder (5322) which is close to the positioning cylinder (533).

15. The battery assembly according to claim 14, wherein the button (51) comprises a receiving part (515) which is an inner hollow part and is defined along an axial direction of the button (51), the receiving part (515) is configured for the rotating shaft (52) to axially slide, and a distance of the rotating shaft (52) sliding in the receiving part (515) is equal to a distance of the elastic member (531) axially moving in the battery sleeve (1).

16. The battery assembly according to claim 14, wherein a positioning ring (9) is defined at an end surface of the battery sleeve (1), the protrusion is a part of the positioning ring (9) sleeved in the battery sleeve (1).

17. The battery assembly according to claim 14, wherein the adjustable resistor (4) comprises a carbon film resistor sheet (41), a first conductive sheet (42), a second conductive sheet (43), and a sliding sheet (44) which is slidably connected to the carbon film resistor sheet (41), the first conductive sheet (42) and the second conductive sheet (43) is fixed at two ends of the carbon film resistor sheet (41) respectively, one end of the rotating shaft (52) which is opposite to the button (51) is firmly connected with the sliding sheet (44), and the sliding sheet (44) is configured to move on the carbon film resistance sheet (41) with a rotation of the rotating shaft (52).

18. (canceled)
